(19) United States
(12) Patent Application Publication
(10) Pub. No.: US 2016/0219020 A1
(43) Pub. Date: Jul. 28, 2016

(54) Dynamically Switchable Captive Portal

(71) Applicant: Nigel Anthony Hathaway, Bristol (GB)

(72) Inventor: Nigel Anthony Hathaway, Bristol (GB)

(21) Appl. No.: 14/997,491

(22) Filed: Jan. 16, 2016

(30) Foreign Application Priority Data
Jan. 23, 2015 (GB) 1501172.9

(51) Int. Cl. H04L 29/06; H04W 12/08

(52) U.S. Cl. CPC H04L 63/0281; H04W 12/08

(57) ABSTRACT

A system in which an audience, each with a computing device, and without printed material, is given restricted access to data as directed by the presenter. The presenter is able to alter the scope and content of the restrictions periodically, and also to direct the audience's computing devices to display particular data. The data presented may include interactive web applications. An exemplary embodiment comprises the presenter's laptop computer 11 from which data is served; the presenter's control tablet 12, which is used to direct and control the operation of the network router 14; laptop computers 13a and tablets 13b belonging to the audience, which display data served by laptop computer 11 and are controlled by tablet 12, by means of network router 14.

### FIELD OF INVENTION

This invention relates generally to communication networks, and more especially to a captive portal scheme where the captive element is dynamically switchable.

### BACKGROUND OF THE INVENTION

The conducting of seminars, particularly complex technical seminars, traditionally involves the production of folders of printed notes. Not only is this expensive and cumbersome, but notes are often given out in advance of the material being presented, so that delegates can refer to them as the seminar progresses. This gives rise to two particular problems: (1) delegates are often distracted by looking ahead at material not yet presented, and (2) it is often easy for delegates to be looking at the wrong page of the notes, thus wasting time and causing distraction. This invention does away with the need for printed notes, and instead presents the same information over a communications network onto the delegates' own devices, such as laptop computers or tablets. The seminar's presenter has control over and restricts what can be displayed on the delegates' devices, which may be just a single page at any particular instant, or it may be a whole web site or set of web sites, which may additionally include interactive elements. This ensures that the delegates are always at the correct place in the material, and prevents them from looking ahead at other material.

### DISCLOSURE OF INVENTION

The present invention comprises a network router, to which connect a plurality of network computing devices, such as general purpose laptop computers or tablets. The network router may also be connected to the public Internet so that material may be retrieved from external sources. In the case where some or all of the material is not being retrieved from the Internet, one or more of the network computing devices may be configured to serve the required material. This will usually be the seminar presenter's own laptop computer. In addition, one or more of the network computing devices is designated as being the controller. The controller is used to direct and restrict the material which is to be displayed on the delegates' computing devices at any one time. The controller may be the same presenter's laptop computer, or another network computing device. As well as functioning as a conventional network router, it is the role of the network router to control and restrict what is presented on the delegates' network computing devices, in response to commands and selections originating from the controller. Advantageously, the material being presented does not need to be modified in any way from the way it operates and is presented in an environment where no direction or restriction is required, in order to function correctly in the aforementioned directed and restricted environment. The network router performs any necessary adaptation of the material.

Applications of this invention are not restricted to teaching seminars, but it may also be useful in other circumstances where it is necessary to restrict and direct the material to be displayed on the devices of network users. Such applications include the provision of supplementary information on guided or interactive tours of museums and buildings, and also the provision of audience interaction facilities at entertainment venues. In the case where the network user is mobile, for example in the context of a tour of a museum or building, it may be advantageous to operate the aforementioned controller on an automated basis where the mode of controlling input is derived from an automated sensing of the network user's physical location. Furthermore, in this and other circumstances, it may be advantageous to automatically operate the controller on the basis of time of day. In all cases, the material presented is advantageously interactive in nature.

### BRIEF DESCRIPTION OF DRAWINGS

For a more complete explanation of the present invention and the technical advantages thereof, reference is now made to the following description and the accompanying drawings in which:

FIG. 1 depicts an exemplary embodiment of a network architecture incorporating the present invention and a plurality of network computing devices;

FIG. 2 depicts an exemplary diagrammatic representation of a network router of the present invention; and

FIG. 3 depicts an exemplary embodiment of a larger network architecture incorporating the present invention.

### BEST MODE FOR CARRYING OUT THE INVENTION

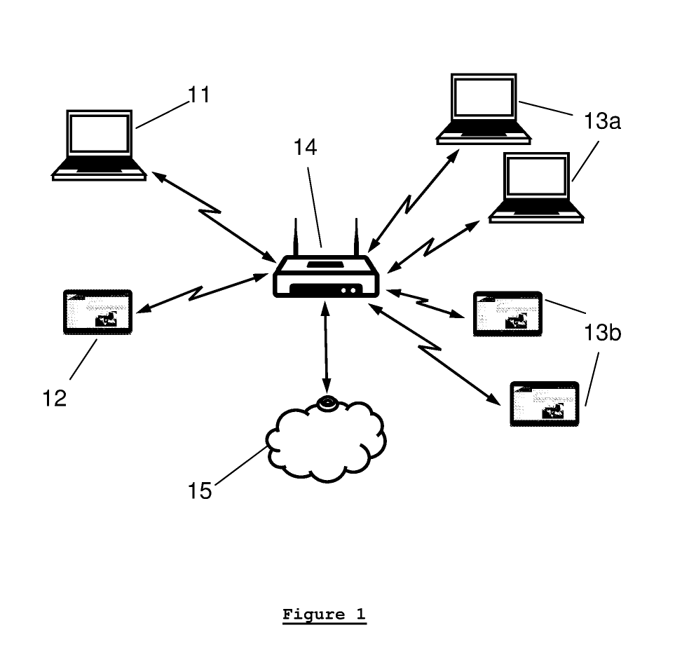

Embodiments of the present invention and their technical advantages may be better understood by referring to FIGS. 1, 2 and 3.

In FIG. 1, the presenter's laptop computer 11, the presenter's tablet computing device 12 and the delegates' laptop computers 13a and tablet computing devices 13b are all connected by means of a network connection to the network router of the present invention 14. Advantageously, the network router uses the unlicensed radio spectrum as its network medium, and thus combines the function of a conventional router and a WiFi wireless access point into the single unit. In addition to a radio network interface, the network router may also have one or more cabled network interfaces which may conventionally be Ethernet interfaces. One of these cabled interfaces may be used as a connection to the Internet 15, in cases where it is desired to give the delegates Internet access. Another such interface may be used for the connection to the presenter's laptop computer to provide its connection to the network router in place of using WiFi for the same purpose. This is advantageous in the case where the presenter's laptop computer 11 provides network server services to the delegates' computing devices 13a and 13b, in that it halves the quantity of network traffic that has to be carried over the WiFi network. As an alternative to using unlicensed radio as the network medium, it may be advantageous to use licensed radio spectrum, using standards such as LTE/4G. In this instance, a combination of greater network bandwidth and range may be achieved. As an alternative to the scheme whereby the presenter's laptop computer 11 provides network server services, an expanded network router 14 may contain data storage and server functionality, so as to itself perform the role of serving material to the delegates' computing devices 13a and 13b.

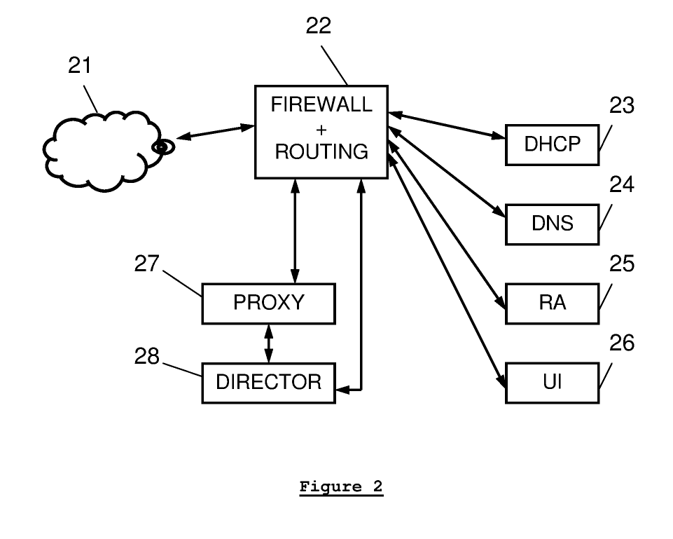

In FIG. 2, the functional elements of the network router of the present invention are depicted. These elements may be implemented as device firmware or in device semiconductor logic, or a combination of the two. The implementation in device semiconductor logic advantageously allows a greater rate of data throughput. The communications network 21 connects to the firewall and routing element 22 through which passes all communications between the communications network and the remaining elements. The Firewall and Routing element 22 controls which elements of Internet protocol (IP) traffic may pass through it; either back to the communications network 21 or to the remaining elements. In addition it modifies IP addresses, Transfer Control Protocol (TCP) port numbers and User Datagram Protocol (UDP) port numbers when routing network traffic between the local network and the Internet, in order to perform a Network Address Translation (NAT) service for IP version 4 (IPv4). The remaining functional elements include:

a Dynamic Host Configuration Protocol (DHCP) server 23, responsible for assigning IPv4 and optionally IP version 6 (IPv6) addresses to network computing devices on the local network;

a Domain Name System (DNS) server 24, responsible for providing domain name to IP address translation which, in the case where the network router is not connected to the Internet, provides the same IP address for all external domain names, which is the IP address of the router itself;

an optional Router Advertisement (RA) server 25 to provide a means by which network computing devices may determine their own IPv6 addresses;

a Configuration Web User Interface (UI) server 26 to provide a means by which the presenter may configure the operating parameters of the network router;

a Web Proxy Server 27 through which all Hypertext Transfer Protocol (HTTP) traffic passes, being redirected and modified as required; and

a Director 28 which dynamically switches the configuration settings of the proxy server 27 in response to commands given by the presenter.

The firewall and routing element 22 is configured to redirect all HTTP (and optionally all encrypted HTTPS) traffic, originally directed both through and to the network router, to the web proxy 27. The web proxy 27 may be partly configured as a conventional Captive Portal, in that, before a delegate has provided authentication credentials, the only web (HTTP) page that is returned to the delegate is the user authentication page. Once a delegate has been authenticated, which is an optional process, then the delegate is presented with a set of facilities restricted by the presenter by means of the controlling network device 11 or 12 (in FIG. 1) functioning in co-operation with the director 28. The presenter is able to alter at any time the set of facilities to which the delegates are restricted. In doing so, he may also direct the page being viewed by the delegate, without the intervention of the delegate. This is implemented by means of a Javascript program, the body of which, or reference to which, is inserted by the Web Proxy 27 into the page which is sent to the delegate's web browser. This Javascript program, which runs in the context of the web page displayed on the delegate's web browser, maintains a communication link to the director 28, and responds to commands from the director 28 by fetching a page from a new web address. The set of restricted facilities and commands to change the delegates' browser web page may be issued to all delegates at the same time, or different sets may be directed to different groups or individual delegates at different times.

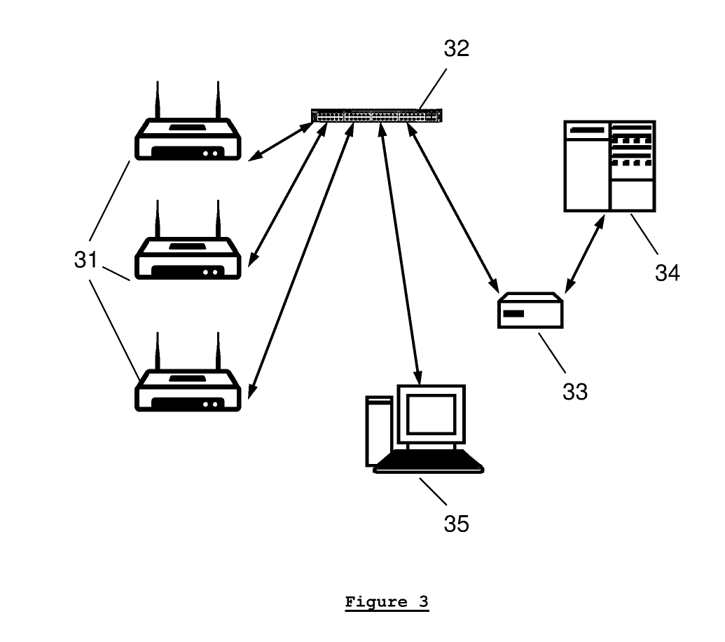

In FIG. 3, the wireless access points 31 are configured in bridge mode, and are connected via a conventional cabled network switch 32 to the network router 33 of the present invention. In this embodiment, the network router has only cabled network connections, and the interface to the radio network is provided by a plurality of separate wireless access points 31. Whereas the embodiment in FIG. 1 comprises entirely of easily portable items of equipment, and is suitable for a smaller venue, the embodiment in FIG. 3 is appropriate to a larger venue with permanently installed equipment. The network router 33 connects to the network server 34 which may be a rack mounted web server. The network router 33 also connects to the controller 35 which may be a conventional desktop computer, co-located, for example, with the lighting and sound controllers of the venue.

1. A router in a communication system which is connected to a plurality of network computing devices, and through which data flows between the aforementioned network computing devices, and whose operation includes internal functional elements which provide:
a firewall and routing function, in order to prevent certain data ingress and to direct certain data to other internal functional elements and to other connected network computing devices; and
a dynamically configurable proxy function, through which data passes, and which selectively alters that data, or substitutes that data with other data, in accordance with patterns and logic which are periodically altered while this function is active; and
a director function which, in response to commands from an external network computing device, alters the patterns and logic governing the aforementioned proxy function, and which also sends commands to external network computing devices, causing them to perform pre-determined functions and tasks.

2. A system as claimed in claim 1, in which the router is also a wireless access point, using unlicensed radio spectrum as the communication medium.

3. A system as claimed in claim 1, in which the router is also a mobile telecommunications base station, using licensed radio spectrum as the communication medium.

4. A system as claimed in any of the preceding claims, in which both cables and radio are used as communication media.

5. A system as claimed in any of the preceding claims, in which connection to network computing devices is additionally or exclusively made indirectly through intermediary network processing and conversion devices.

6. A system as claimed in any of the preceding claims, in which the router additionally acts as a network data server.
